(19) United States
(12) Patent Application Publication
(10) Pub. No.: US 2019/0005578 A1
(43) Pub. Date: Jan. 3, 2019

(54) System and Method for Transforming, Valuing, and Issuing Carbon Capture Credits

(71) Applicant: Shawn Gagne, Greensboro, NC (US)

(72) Inventor: Shawn Gagne, Greensboro, NC (US)

(21) Appl. No.: 15/640,954

(22) Filed: Jul. 3, 2017

(51) Int. Cl. G06Q 40/04; G06Q 30/00

(52) U.S. Cl. CPC G06Q 40/04; G06Q 30/018

(57) ABSTRACT

This document presents a system and method for bundling environmental credits from a known qualified and verified domestic project with commodity offsets, grading the resulting bundle based upon the likelihood of a holder's avoidance of carbon-emission based regulatory penalties, and valuing the resulting graded bundle for sale. In an embodiment, any given bundle contains an aggregate sum of environmental conservation values sufficient to issue a tradable environmental commodity. The system and method described herein provides for a software-based solution for such grading, valuing, and offering for sale tradable environmental commodities.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

This innovation relates generally to the market for Carbon Capture Credits, which are defined as any financial instruments, tradable certificates or permits that allow the holder, to emit one ton of carbon dioxide or the mass of another greenhouse gas with a carbon dioxide equivalent (tCO₂e) equivalent to one ton of carbon dioxide. The carbon capture market is designed to address the man-made contributors to climate change through a marketplace-based solution. Large-scale contributors of carbon emissions are subject to government-mandated financial penalties for failure to limit those emissions to prescribed levels. In an effort to avoid such penalties, emitters often elect to adopt technological solutions, such as use of more efficient engines, or use of smokestack “scrubbers” to curb overall emission levels.

Other entities with “carbon neutral” or “carbon negative” emissions may be in a position to offer “Carbon Capture Credits” to further offset the emissions of large-scale carbon contributors. These credits become financially self-regulating through their being tendered on a formal market exchange, with the healthy byproduct being the overall reduction in total global greenhouse gas emissions.

Various methods of correlating greenhouse gas emission reduction and marketplace valuation of the same have been attempted. For instance, some methods have involved planting tree groves, the carbon dioxide reduction capacity of which serves as a base for calculation of carbon offsets, then registering as a carbon credit exchange provider or aggregator, exchanging the offset certificate for a greenhouse gas emission credit or carbon offset, and generating a tradable commodity that can be purchased or sold for use in managing carbon dioxide emissions.

Another method makes use of a financial instrument that is determined to have an at least partially neutralized carbon footprint, the instrument being generated by storing at least one security and a separate carbon credit in a trust. Other methods specifically address the planting of trees as a method of creating carbon offsets, which can then be packaged and sold.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a data process system consistent with certain embodiments of the present invention.

FIG. 2 is an alternate view of a data process system consistent with certain embodiments of the present invention.

FIG. 3 is an alternate, detailed view of a data process system consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “carbon credit” refers to any financial instrument, tradable certificate or permit that allows the holder to emit one ton of carbon dioxide or the mass of another greenhouse gas with a carbon dioxide equivalent (tCO₂e) equivalent to one ton of carbon dioxide.

Carbon credits sold on modern exchanges can vary widely in price. As such, the same buyer may pay different amounts for the same quantity of carbon “reduction.” Variation in pricing in the domestic carbon capture market appears to be a function of the perceived value of the project source that generates the carbon credit and the proximity of that source to the buyer or the buyer's market.

In an exemplary embodiment, a type of project source with a high perceived worth is one based upon the planting of live trees. By combining the heightened credit generated by such a “tree planting” project (or similarly qualified and verified domestic project) with separately provided commodity offsets, a more highly valued product can be produced. In an embodiment, the value of the product is greater in both perceived and actual value, and the product is referred to as “Offset Bundles.”

Offset Bundles, as financial instruments, can be characterized by their calculable level of risk. A high-risk bundle would be characterized by speculative protection from violations of government regulations. A low-risk bundle would be characterized by minimal exposure to said violations.

These bundles, carrying variable levels of risk, may be offered to customers in a manner similar to the offer of a mutual fund. The analogy of mutual fund is apt: a mutual fund created as a collection of parts with variations in real and perceived value is characterized by a level of risk generated by the sum of the risks inherent in the stocks and bonds it contains. Offset Bundles can be similarly characterized and sold on an exchange or through proprietary software.

In an embodiment, the innovation described herein is a system for transforming carbon capture credits. The system includes a user interface, a server having a processor in communication with one or more databases, a software module operative to value carbon capture credit bundles, a software module operative to offering said bundles for sale, combining bundled offsets from community activities with existing offset credits to create a mutual fund, creating an increase of value of carbon credits due to combining said bundled offsets with higher value carbon credits, and registering, valuing, and issuing offset bundles of varying values for sale. In this non-limiting system embodiment, databases employed include computed environmental conservation values, and the value of carbon capture credit bundles is a function of environmental conservation values perceived in bundled offsets and existing offset credits.

In addition, the non-limiting exemplary mutual fund is a professionally managed program trading in diversified holdings, the increase of value of carbon credits is measured as a function of the market price prospective holders will pay to acquire, and the totality of registering, valuing, and issuing of Offset Bundles is affected by computer-based software.

In an alternate embodiment, the innovation described herein is a method for transforming carbon capture credits. The method involves combining bundled offsets from community activities with existing offset credits to create a mutual fund, creating an increase of value of carbon credits due to combining said bundled offsets with higher value carbon credits, and registering, valuing, and issuing offset bundles of varying values for sale.

The non-limiting exemplary method described further includes a user interface, a server having a processor in communication with one or more databases, a software module operative to value carbon capture credit bundles, and a software module operative to offering said bundles for sale. Further, in such an embodiment any mutual fund is to be a professionally managed program trading in diversified holdings, and any increase of value of carbon credits is measured as a function of the market price prospective holders will pay to acquire.

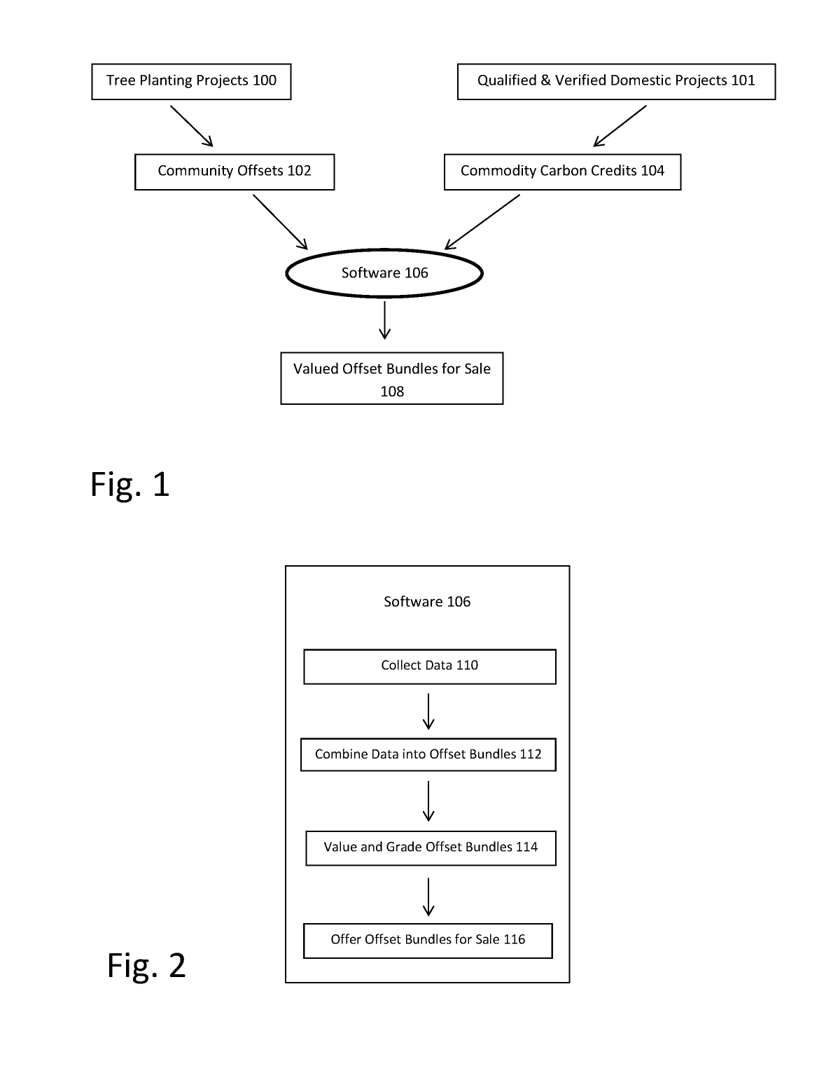

Turning now to FIG. 1, this figure presents a view of a data process system consistent with certain embodiments of the present invention. The management of Tree Planting Projects 100 results in the creation of Community Offsets 102. Tree Planting Projects 100, in a non-limiting example, includes a campaign to plant one or more trees at a public school. So planting a tree in such a locality creates many times more value to a local customer than planting the same tree in a place where no one can see it. This Location Value results in quantifiable Community Offsets 102 and locally planted trees. The value attached to the location of the offset source (in this non-limiting example, a public school and a tree, respectively) is perceived by a potential purchaser of Credits as insurance against financial and reputational risks.

In an embodiment, Community Offsets 102 are expressed as a function of carbon credits, where each carbon credit represents one metric ton of carbon dioxide or carbon dioxide equivalent removed or reduced from the environment. The value of such Community Offsets 102 is made variable by the inclusion of Location Value as a factor in any valuation equation. Likewise, the selection of Qualified and Verified Domestic Projects 101 results in Commodity Carbon Credits 104, similarly calculated based upon the removal or reduction of one metric ton of carbon dioxide or carbon dioxide equivalent per credit. The value of Commodity Carbon Credits 104 may fluctuate based upon a variety of perceived financial and reputational risks. In a non-limiting example, Community Carbon Credits 101 and Community Offsets 102 are entered into Software 106 for processing. Software 106 outputs Valued Offset Bundles for Sale 108. Valuation of Offset Bundles is based upon the totality of perceived financial and reputational risks to which the prospective buyer is exposed.

Turning now to FIG. 2, this figure presents an alternate view of a data process system consistent with certain embodiments of the present invention. Software 106 performs the functions off Collect Data 110, Combine Data into Bundles 112, Value and Grade Bundles 114, and Offer Bundles for Sale 116. The data used in the steps of Collect Data 110 and Combine Data in to Bundles 112 takes the form of Community Offsets and Commodity Carbon Credits. The Community Offsets result from the management of Tree Planting Projects. Likewise, the Commodity Carbon Credits result from the selection of Qualified and Verified Domestic Projects.

Different bundles offer different levels of risk avoidance. The risk inherent in any given bundle is that the bundle may fail to insulate a holder of the bundle from regulatory penalties. The return on the purchase of any given bundle is measured by the avoidance of regulatory penalties.

Value and Grade Bundles 114 combines the steps of valuation and grading based upon risk. The valuation of any given bundle is made based upon the perceived value of the Tree Planting Project and any specific Qualified and Verified Domestic Project in combination with the proximity of each Project's source to the buyer or the buyer's market. Valuation as a function of the two data sets combined produces higher overall values per bundle. The value of any given bundle can be expressed as a ratio of the characteristics of the two data sets: Community Offsets and Commodity Carbon Credits.

The grading of any given bundle is made based upon the likelihood of any given buyer avoiding regulatory penalties. In a non-limiting example, Tree Planting Project may enjoy a very high level of penalty avoidance X, representing 100% risk avoidance. Each Qualified and Verified Domestic Project may carry a variable level of penalty avoidance 1/X. In combination, each bundle containing Community Offsets from Tree Planting Projects and Commodity Carbon Credits from Qualified and Verified Domestic Projects inherently carries a level of risk avoidance varying from 100% to near 0%. Based upon the resulting level of risk, each bundle may be graded and then submitted to the step of Offer Bundles for Sale 116.

The grading and offering for sale of Offset Bundles as described herein is analogous to the creation and offering for sale of the financial instrument known as a Mutual Fund. A mutual fund is an investment vehicle that is composed of interest in a variety of stocks and bonds. Each stock and bond represented in a mutual fund carries its own level of risk for a return on investment; the combined stock-and-bond corpus of the mutual fund carries its own distinct level of risk that can be expressed as a function of the level of risk of each constituent stock and bond. The return on investment typically sought by a holder of any given mutual fund is the increase in the monetary value of the original investment. The attractiveness of any given mutual fund as a vehicle for increased wealth is based upon the likelihood of maximization of monetary return and minimization of monetary loss. Each of the corpus-constituent stocks and bonds carries variations in perceived and real value, the combination of which results in risk capable of being graded and an investment product capable of being valued. In the exemplary embodiment described herein, the Community Offsets and Commodity Carbon Credits are analogous to the stocks and bonds of a mutual fund. The regulatory-penalty avoidance of the exemplary embodiment described herein is analogous to the combined maximization of monetary return and minimization of monetary loss of a mutual fund.

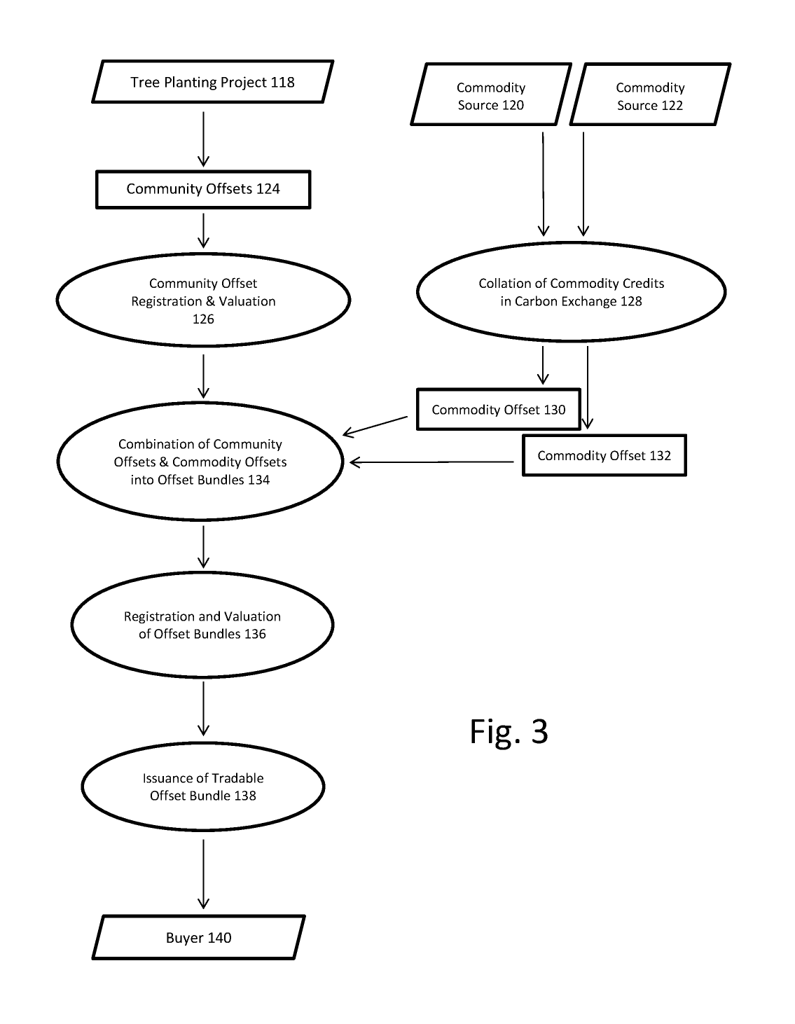

Turning now to FIG. 3, an alternate, detailed view of a data process system consistent with certain embodiments of the present invention is presented. Tree Planting Project 118 produces value to a customer based upon its proximity to and resulting visibility in the customer's market. Tree Planting Project 118 produces Community Offsets 124. The value attached to the location of the Offset source is perceived as insurance against financial and reputational risks. Community Offsets are registered and valued at 126. This registration and valuation is performed through implementation of proprietary software on a dedicated server.

Meanwhile, commodity sources analogous to Tree Planting Project 118 produce commodity carbon credits. Commodity Source 120 and Commodity Source 122 produce commodity credits that are collated into a carbon exchange at 128. The carbon exchange of 128 produces any number of commodity offsets similar to Commodity Offset 130 and Commodity Offset 132. Each of Commodity Offset 130 and Commodity Offset 132 bears a variable amount of financial and reputational risk as a function of regulatory violation avoidance.

At 134 community offsets are combined with commodity offsets to produce Offset Bundles. At 136 the resulting Offset Bundles are registered and valued. The steps of combining community offsets with commodity offsets, and of registering and valuing resulting Offset Bundles are performed through implementation of proprietary software on a dedicated server. The value and price of any individual Offset Bundle is a function of the customer-perceived level of financial and reputational risk, which is itself a function of the bundle's level of regulatory violation avoidance. At 138 the registered and valued Offset Bundle is issued as a tradable commodity to Buyer 140 via a proprietary software and dedicated server platform.

While certain illustrative embodiments have been described, it is evident that many alternatives, modifications, permutations and variations will become apparent to those skilled in the art in light of the foregoing description.

What is claimed is:

1. A system for transforming carbon capture credits, comprising:
a user interface;
a server having a processor in communication with one or more databases;
a software module operative to offer carbon capture credit bundles for sale where said carbon capture credit bundles combine a community activity carbon offset with pre-defined, existing offset credits to create a mutual fund;
a software module operative to analyze the value of carbon credits due to combining said community activity carbon offsets with said existing offset credits to quantify the change in value of carbon capture credit bundles included in said mutual fund; and
a software module for registering, valuing, and issuing said carbon capture credit bundles within said mutual fund.

2. The system of claim 1, where said one or more databases include computed environmental conservation values.

3. The system of claim 1, where said value of carbon capture credit bundles is a function of environmental conservation values perceived in bundled offsets and existing offset credits.

4. The system of claim 1, where said mutual fund is a professionally managed program trading in diversified holdings.

5. The system of claim 1 where said change in value of carbon capture credit bundles is measured as a function of the market price for commodity offset credits combined with one or more registered and valued community offsets.

6. The system of claim 1 where a software module is operative to calculate the value and price of any carbon capture credit bundles as a function of the level of financial and reputational risk based upon the level of the carbon capture credit bundle regulatory violation avoidance.

7. A method for transforming carbon capture credits, comprising:
offering carbon capture credit bundles for sale where said carbon capture credit bundles combine a community activity carbon offset with pre-defined, existing offset credits to create a mutual fund;
analyzing the value of carbon credits due to combining said community activity carbon offsets with said existing offset credits to quantify the change in value of carbon capture credit bundles included in said mutual fund; and
registering and valuing the carbon capture credit bundles as a function of the level of financial and reputational risk for said carbon capture credit bundles; and
issuing said carbon capture credit bundles within said mutual fund.

8. The method of claim 7, further comprising one or more databases established in a server to store computed environmental conservation values.

9. The method of claim 7, where said value of carbon capture credit bundles is a function of environmental conservation values perceived in bundled offsets and existing offset credits.

10. The method of claim 7, where said mutual fund is a professionally managed program trading in diversified holdings.

11. The method of claim 7, where said change in value of carbon capture credit bundles is measured as a function of the market price for commodity offset credits combined with one or more registered and valued community offsets.

12. The method of claim 7, where registering and valuing the carbon capture credit bundles as a function of the level of financial and reputational risk for said carbon capture credit bundles based partially upon the level of the carbon capture credit bundle regulatory violation avoidance.
